(19) United States
(12) Patent Application Publication
(10) Pub. No.: US 2011/0215903 A1
(43) Pub. Date: Sep. 8, 2011

(54) Apparatus and Associated Methods

(75) Inventors: Jun Yang, Milpitas, CA (US); Hong Lu, Hanover, NH (US); Zhigang Liu, Sunnyvale, CA (US)

(73) Assignee: NOKIA CORPORATION, Espoo (FI)

(21) Appl. No.: 12/717,364

(22) Filed: Mar. 4, 2010

(51) Int. Cl. G08B 5/22

(52) U.S. Cl. 340/8.1

(57) ABSTRACT

In one or more embodiments described herein, there is provided an apparatus configured to identify a particular motion state of a portable electronic device, and vary the geographical location data sampling rate for the portable electronic device based on the identified particular motion state of the portable electronic device.

### TECHNICAL FIELD

The present disclosure relates to the field of geographical location data sampling devices and associated methods and computer programs. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs), Global Positioning System (GPS) location devices, assisted-GPS (A-GPS) devices (which use an available cellular network to facilitate location determination, mobile phones, and the like.

The portable electronic devices/apparatus according to one or more disclosed aspects/embodiments may provide one or more audio/text/video communication functions (for example, tele-communication, video-communication, and/or text transmission (Short Message Service (SMS)/Multimedia Message Service (MMS)/emailing) functions), interactive/non-interactive viewing functions (for example, web-browsing, navigation, TV/program viewing functions), music recording/playing functions (for example, MP3 or other format and/or (Frequency Modulation (FM)/Amplitude Modulation (AM)) radio broadcast recording/playing), downloading/sending of data functions, image capture function (for example, using a (for example, in-built) digital camera), and gaming functions.

### BACKGROUND

A number of portable electronic devices are often equipped with the ability to sense, query and share human-centric context information, such as geographical/physical location and social activities. With the progress of such technology, more applications that are ‘location aware’ are being created, developed, and deployed for long term use. Such uses can involve health monitoring, significant place detection, and other location-based services. Such applications rely on location feeds provided by location sensors (GPS, Wi-Fi, Global System for Mobile communication (GSM) and/or the like) built in or attached to the portable electronic device. Location sensors (such as GPS sensors) can be power hungry and can be power intensive to run. For example, the GPS sensor on some current mobile telephones can drain a fully charged standard battery in 8-9 hours without running any other applications.

Traditional power management of location sensors is often poll-based. For example, the location sensor is instructed to obtain a location reading at specific pre-defined/pre-determined time intervals (for example, every 5 seconds).

In real life, mobile phones and portable electronic devices are often multi-functional, providing many functions to their users. Such functions include performing/establishing voice calls, emails, SMS, audio player and pictures, and/or the like. As such, intensive battery usage by a location sensor impinges on the power available to/for other functions. In some cases, only a certain amount of battery power of the total power reserve is allocated specifically to the location sensor (via an energy budget). The energy budget available for localization purpose is sometimes only a small fraction of the battery capacity. For example, if the energy budget is set to be 25% of the total power reserve, continuous GPS sensing would have a limited sustained operation time (for example, only 2-3 hours in some devices).

Therefore, the problem of a limited energy budget has become a major constraint for geographical location sensing/sampling capability in mobile phones. How to reduce the consumption of energy by geographical location sensors is becoming a problem in many location sensing applications. Additionally, some location based services may require a particular level of accuracy and/or specific operation time. These objectives can be challenging to meet with methods and apparatus presently known in the art.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect, there is provided an apparatus configured to:

identify a particular motion state of a portable electronic device; and

vary the geographical location data sampling rate for the portable electronic device based on the identified particular motion state of the portable electronic device.

The apparatus may be configured to identify a particular motion state based on one or more of detected:

speed, direction, velocity, acceleration, deceleration, forces, torque, and/or change in any of these quantities experienced by the portable electronic device.

These quantities may be provided by a portable electronic device, or components of a portable electronic device, such as an accelerometer and/or the like.

The particular motion state may be selected from a group comprising one or more of: stationary, walking, running, cycling and/or in-vehicle. There may be other intermediary motion states that describe motion states between stationary and walking, walking and running, running and cycling, and/or the like.

In-vehicle may be car, train, bus, airplane, tram, taxi, bike, boat, and/or the like. Other vehicles or methods of transportation may also be covered by the in-vehicle motion state, or they may each have their own distinct motion state.

Each of the motion states may be associated with a particular sampling rate, the apparatus being configured to vary the geographical location sampling rate based on the particular sampling rate associated with the particular identified motion state.

Each of the motion states may be associated with a particular weighting, the apparatus being configured to accumulate the respective weightings of one or more identified motion states and compare the accumulated weighting value with a predetermined threshold to determine the sampling rate.

This allows the apparatus to instruct that a data sample be taken when the accumulated weighting value exceeds a predetermined threshold.

The apparatus may be configured to accumulate the respective weightings of one or more identified motion states over a period of time and compare the accumulated weighting value with a predetermined threshold to determine the sampling rate.

The apparatus may further be configured to:

identify a particular energy level of the portable electronic device; and

vary the geographical location data sampling rate for the portable electronic device based on the identified particular motion state and the identified particular energy level of the portable electronic device.

This allows the apparatus to further correlate identified motion states with the energy level of the portable electronic device to determine an appropriate sampling rate that satisfies both conditions. For example, for a given motion state when the energy level remaining is high, the sampling rate may be higher than for the same motion state when the energy level remaining is low, as there is a greater amount of energy remaining and available for geographical location sampling in the first situation than the second situation.

The apparatus may be configured to be able to access a policy table, wherein the policy table stores a plurality of sampling rates, each sampling rate being associated with a particular motion state and a particular energy level of the portable electronic device, the apparatus being configured to vary the geographical location data sampling rate in accordance with the particular sampling rate associated with the identified motion state and identified energy level of the portable electronic device.

The policy table may be pre-determined, pre-generated, generated by the apparatus during use, pre-generated and updated by the apparatus during use, and the like. This policy table can be preloaded onto a portable electronic device or apparatus to allow the apparatus to identify appropriate sampling rates based on the identified motion state/states and the energy level of the portable electronic device.

The policy table may be generated/populated in accordance with a Markov Decision Process (MDP). The MDP model statistically models this stochastic process (in other words, a system where the outcome is partially random and partially influenced by decisions made in a given state) to populate the policy table, whereby each entry correlates each identified motion state with each energy level.

The table may be populated based upon a predetermined criterion, the predetermined criterion comprising one or more of: energy level of a battery of a portable electronic device; battery draining rate for a given sampling rate; duration of geographical location sensing operation/session; an individual user's daily mobility pattern; and a reward function for different sampling rates.

The apparatus may be configured to continuously iterate and perform the above functions, or it may be configured to perform the above functions at discrete iterations at set time intervals. The apparatus may be configured to identify the current motion state/energy level of a portable electronic device, and store one or more of these current states as previous states/levels of the device.

In a second aspect, there is provided a processor configured to

identify a particular motion state of a portable electronic device; and

vary the geographical location data sampling rate for the portable electronic device based on the identified particular motion state of the portable electronic device.

There is provided an apparatus comprising the processor of the second aspect and a memory including computer program code, wherein the memory and the computer program code configured to, with the processor, cause the apparatus at least to

identify a particular motion state of a portable electronic device; and

vary the geographical location data sampling rate for the portable electronic device based on the identified particular motion state of the portable electronic device.

In a third aspect, there is provided a portable electronic device comprising the apparatus of the first aspect, or the processor of the second aspect.

In a fourth aspect, there is provided an apparatus comprising:

means for identifying a particular motion state of a portable electronic device; and

means for varying the geographical location data sampling rate for the portable electronic device based on the identified particular motion state of the portable electronic device.

In a fifth aspect, there is provided a method comprising:

identifying a particular motion state of a portable electronic device; and

varying the geographical location data sampling rate for the portable electronic device based on the identified particular motion state of the portable electronic device.

The method may comprise identifying a particular motion state based at least partially on one or more of detected: speed, direction, velocity, acceleration, deceleration, forces, torque, and/or change in any of these quantities experienced by the portable electronic device.

In a sixth aspect, there is provided a computer readable medium comprising a computer program stored thereon, the computer program comprising:

program code for identifying a particular motion state of a portable electronic device; and

program code for varying the geographical location data sampling rate for the portable electronic.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:—

FIG. 1a illustrates a geographical location sampling trace of a portable electronic device being carried by a person who is driving, the trace being taken in accordance with the apparatus of the first embodiment;

FIG. 1b illustrates a geographical location sampling trace of a portable electronic device being carried by a person who is walking, the trace being taken in accordance with the apparatus of the first embodiment;

FIG. 2 illustrates an apparatus according to a first embodiment.

FIG. 3 illustrates power consumption of a portable electronic device over time due to a GPS sensor;

FIGS. 4a-4d illustrate geographical location sampling policy tables generated at four different time intervals/ticks;

FIGS. 5a-5c illustrate generated sampling rates compared against energy level of a portable electronic device over time;

FIG. 6 illustrates schematically a system diagram of adaptive geographical location sampling according to another embodiment;

FIG. 7 illustrates a method of operation according to another embodiment;

FIG. 8 illustrates schematically a computer readable media providing a program according to an embodiment of the present invention.

### DESCRIPTION OF EXAMPLE ASPECTS/EMBODIMENTS

In one or more embodiments described herein, there is provided an apparatus configured to identify a particular motion state of a portable electronic device, and vary the geographical location data sampling rate for the portable electronic device based on the identified particular motion state of the portable electronic device.

By identifying the type of motion that the portable electronic device is going through, it is possible to elect a sampling rate that is most appropriate for the motion experienced by the device.

For example, if a user is walking they are likely to be moving at approximately 1-2 metres per second. In contrast, if a person is driving they might be moving at anywhere from 10-30 metres per second (approximation). A suitable sampling rate for the first ‘walking’ situation may not be appropriate for the second ‘driving’ situation, and vice versa. Identifying these different motion types can allow for a suitable sampling rate to be adopted based on which motion type is currently being experienced by the device.

In the walking case, the device will cover less ground in a given time period than the driving case, and therefore geographical location will not change radically over time (relative to driving). As such, geographical location data sampling can be performed less frequently without substantially affecting the accuracy of the reported geographical location. In contrast, in the driving case the device will cover a lot of ground in the same period of time, and the geographical location could change very quickly over time (relative to the walking situation). Therefore, a more frequent geographical location data sampling is helpful to keep track of a device moving at such speed. By varying the sampling rate to suitably match the motion state, it is possible to adaptively optimize the rate of sampling, and thereby improve performance and battery life of such portable electronic devices. For example, the energy cost of continuous motion state monitoring is very low in comparison to the energy required to constantly take geographical location data samples according to methods presently known in the art.

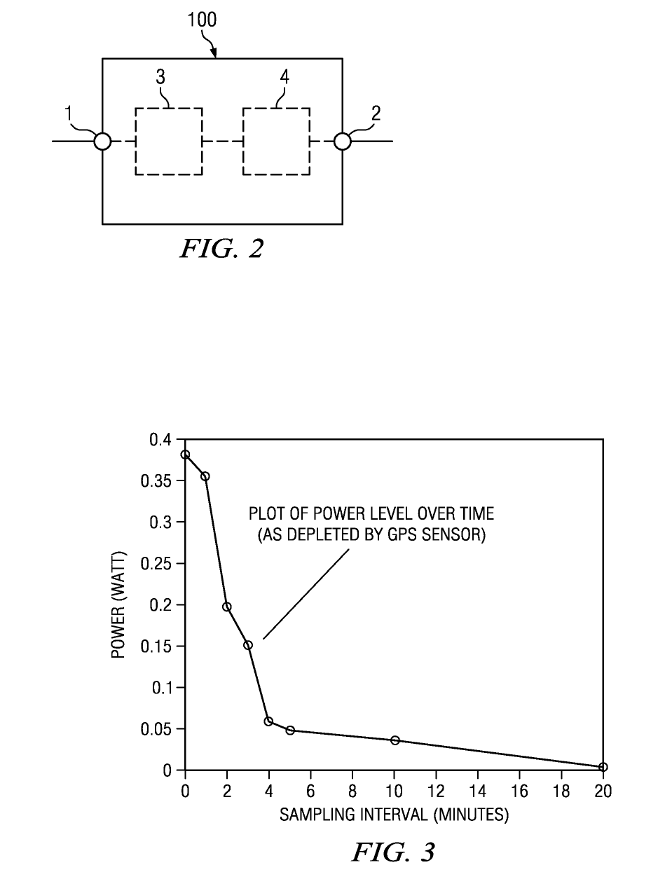

We will now describe a first embodiment with reference to FIG. 2.

FIG. 2 illustrates apparatus 100. The apparatus 100 comprises input 1, output 2, identification circuit 3 and sampling control circuit 4.

In this embodiment, the apparatus 100 is a processor. The processor is an Application Specific Integrated Circuit (ASIC) that has functional blocks providing each component integrally formed as part of the processor (described in detail below). The skilled person will appreciate that in other embodiments the various components may be separate from each other and/or distributed separately/remotely from each other.

The input 1 is for receiving signalling indicative of motion of an electronic device. This is to be provided onward to the identification circuit 3. Identification circuit 3 is a functional block that is part of the ASIC processor/apparatus 100 and is able to operate on signalling received from the input 1 to identify a motion state of a corresponding portable electronic device based on the received signalling. In this embodiment, the identification circuit 3 receives the signalling and uses this to identify a particular motion state that correlates to the received signalling.

In some embodiments this is done by identifying unique characteristics of the signalling that are indicative of particular types of motion and comparing these against predetermined unique characteristics for particular motion states. The identification circuit 3 is also configured to provide an output indicative of the identified motion state onward to the sampling control circuit 4.

Sampling control circuit 4 is a functional block that is able to take the output from the identification circuit 3 that is indicative of a particular motion state of a portable electronic device and operate on that information to vary the geographical location sampling rate of the portable electronic device. Depending on the identified motion state, the sampling control circuit 4 can determine what the sampling rate should be for that given motion state (for example, based on predetermined criteria), or whether geographical location data sampling should or should not be performed at that instant based on the particular identified motion state. The sampling control circuit 4 is also configured to provide an output onward to output 2 that can control the sampling rate of the geographical location sensor of a portable electronic device. This is done after the sampling control circuit has performed its operation on the signalling from the identification circuit 3.

The output 2 is for providing signalling that is indicative of what the geographical location data sampling rate is to be.

In this embodiment, the input 1 and the output 2 are part of/define a connection bus that electrically interfaces the processor/apparatus 100 with a portable electronic device. The skilled person will appreciate that, in other embodiments, the input 1 and output 2 may be other components that allow for electrical communication to the processor/apparatus 100. This can allow the completed processor/apparatus 100 to be installed into a portable electronic device. The skilled person will appreciate that in other embodiments the processor/apparatus 100 may be remotely located from the portable electronic device and receive signalling at a different location

We will now describe the assembly of this apparatus 100.

As part of forming the processor/apparatus 100, the input 1 is electrically connected to the identification circuit 3, the identification circuit 3 is electrically connected to the sampling control circuit 4, and the sampling control circuit 4 is electrically connected to the output 2.

In this embodiment, the identification circuit 3 and sampling control circuit 4 are separate functional blocks that are integrally formed with the respective connected input and output 1, 2 so as to form a single processor 100. As discussed above, the skilled person will appreciate that there are other examples of embodiment in which the circuits 3, 4 are not integrally formed as a single processor but are kept as distinct functional blocks. These may be located together or separately, within a portable electronic device or remotely from such a device.

We will now describe the operation of this embodiment.

In this embodiment, the processor/apparatus 100 is electronically integrated with a portable electronic device having geographical location sensing capability and also having an accelerometer (for example, such as in the Nokia™ N95, or the Apple™ iPhone™). Please note the accelerometer is not shown in the figures.

The accelerometer is able to provide an indication as to the movement and general motion of the portable electronic device. This indication can be provided as signalling to the processor/apparatus 100 via input 1 and onward to the identification circuit 3. The type of motion that the device is experiencing will determine/affect the nature of the signalling produced by the accelerometer (as discussed above).

The identification circuit 3 takes the received indication signalling from the accelerometer and uses this to identify the motion state of the device. In one example of this embodiment, the identification circuit categories motion into five different categories: STATIONARY, WALKING, RUNNING, CYCLING, and VEHICLE. For example, if the user is walking then the signalling generated by the accelerometer will be particular to ‘walking’ rather than ‘running’ or ‘cycling’ or any other motion state. Therefore, the ‘walking’ signalling will be identified by the identification circuit 3 as a ‘walking’ motion state. In another example, if the user is driving then corresponding signalling generated by the accelerometer will be identified by the identification circuit 3 as a ‘vehicle’ motion state.

In other embodiments, an accelerometer may or may not be present and the motion states may be selected by a user from a set of predetermined motion states.

Once a particular motion state has been identified by the identification circuit 3, this identified state is then passed/indicated to the sampling control circuit 4. As discussed above, this circuit 4 takes the identified motion state and uses this to change/vary the geographical location data sampling rate.

In this particular embodiment, the sampling control circuit 4 operates using a rule-based approach. A sample pseudo-code is provided below to illustrate this approach:

```
/* Constant (chosen by approximate speed ratio between different motion
states) */
int SCORE_STATIONARY = 0;
int SCORE_WALKING = 1;
int SCORE_RUNNING = 4;
int SCORE_CYCLING = 4;
int SCORE_VEHICLE = 20;
int SCORE_THRESHOLD = 80;
int score = 0;
int motion_state_frame = 4; /* seconds */
loop forever
  for each motion_state_frame
  classify current motion state by accelerometer data
  if motion_state = STATIONARY, score = score +
  SCORE_STATIONARY
  else if motion_state = WALKING, score = score +
  SCORE_WALKING
  else if motion_state = RUNNING, score = score +
  SCORE_RUNNING
  else if motion_state = CYCLING, score = score + SCORE_CYCLING
  else if motion_state = VEHICLE, score = score + SCORE_VEHICLE
  if score >= SCORE_THRESHOLD, read GPS and reset score to 0
  end for loop
end outer loop
```

This rule-based approach operates by assigning a particular weighting or value to each type of motion state. The weighting for each motion state can be considered to be an approximation (or relative measure) of the relative speed (for example, in metres per second) of the person/user of the device travelling in that state, but this need not be the case in different embodiments. The assigned weightings can also be considered to be a relative ‘score’ for each state. Respective weightings are calculated and added to a running ‘score’ or ‘value’ (that initially starts at ‘0’) throughout each iteration of the code. This running cumulative score is then compared to a threshold value in each iteration. This threshold value corresponds to the length of a particular frame. To illustrate this rule-based approach in operation, we will discuss the iterative process in detail below.

In one example of this embodiment, the weighting for a motion state for an arbitrary first frame is identified and then added to the running score (which may or may not start at ‘0’). This score is then compared to a threshold value. If the score equals or exceeds the threshold value, then the sampling control circuit 4 controls the portable electronic device to perform a data sampling action and the running cumulative score is reset to ‘0’. If the running score does not equal or exceed the threshold value, then the sampling control circuit 4 does not cause the portable electronic device to perform a data sampling action. Instead, the score is stored as a cumulative ‘score’ or ‘value’ and held over to the next iteration.

In the next iteration, a particular motion state is identified and the corresponding weighting is added to the running cumulative score (whether reset to ‘0’ or not). This updated score is then compared to the threshold value. Again, if the score equals or exceeds the threshold value, the sampling control circuit 4 causes the portable electronic device to perform a data sampling action and the score is reset to ‘0’. If the running score does not equal or exceed the threshold value, then sampling is not performed and the score is held over to the next iteration. This is performed continuously so as to monitor the motion states of the device. In other embodiments, there is a short delay between each iteration (for example, every 1-2 seconds) so that the process is performed at discrete quantized time intervals.

The threshold value therefore determines the point at which the sampling control circuit 4 determines that a geographical location sample should be taken. This threshold can therefore be changed so as to set a desired frame length after which a sample should be taken. As each weighting/score for each respective motion state is a relative measure of the speed of movement of those states, this can be set to allow for a sample to be taken at predetermined cumulative motion intervals in an adaptive manner that is less rigid than current systems.

In another embodiment, each motion state has a corresponding sample rate that the sampling control circuit 4 is configured to apply once the sampling control circuit 4 has received an indication that a particular motion state has been identified.

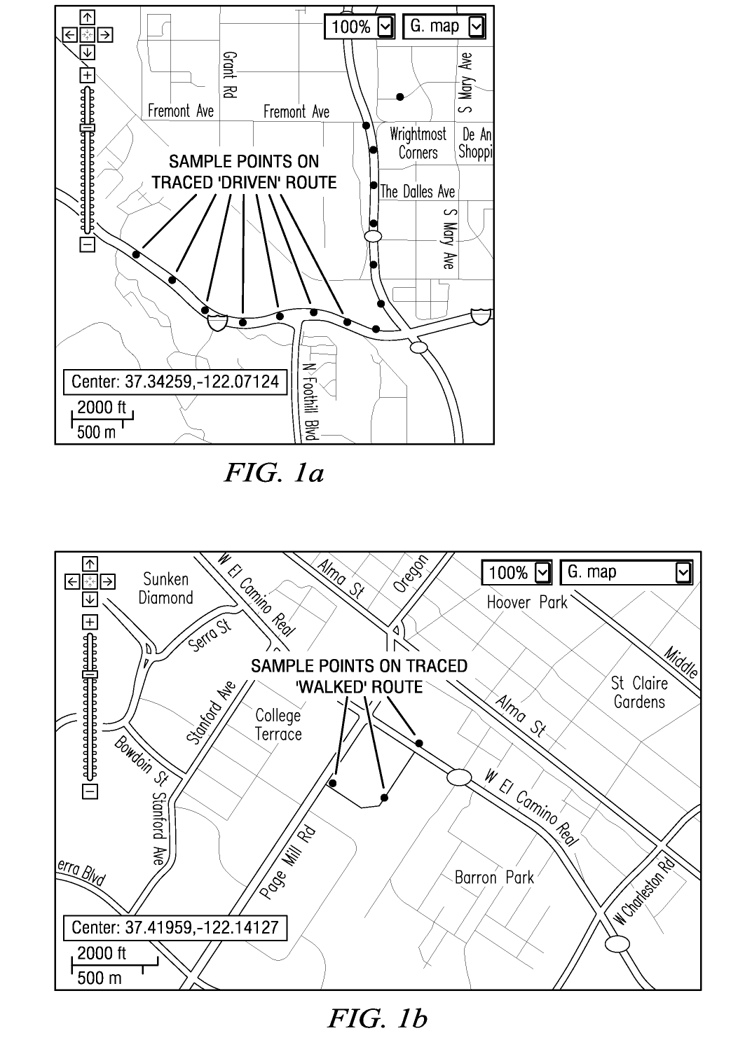

To illustrate the advantages of this system, FIG. 1a shows an example of a trace of data samples taken along a driven route, and FIG. 1b shows an example of a trace of data samples taken along a route that was walked, samples being taken in accordance with the rule based approach discussed above. Both were generated by using above rules. The driven route has readings taken more often with respect to time (relative to the walking route) to keep an accurate track on the vehicle. FIGS. 1a & 1b indicate that this simple approach can capture a person's trace under different motion speeds whilst maintaining low power consumption.

By continuously detecting motion states (for example, stationary, walking, running/cycling, and in vehicle) of the device it is possible to optimally plan for and schedule geographical location data sampling. In particular, the motion states can be used as an estimation of the person's motion speed at any point in time and from there the distance the person has travelled since the last sampling can be determined. If the distance is close to the sample granularity/desired resolution governed by the respective weightings and predetermined threshold values discussed above, the apparatus 100 will instruct another geographical location data sample be taken. This is also advantageous as the energy cost of continuous motion state monitoring is very low (for example, around 40 mw on the Nokia™ N95 8 GB in some tests). With further optimisation for this or other devices, this power consumption could be made to be even lower.

Other embodiments can also take into account different user's needs. For example, other techniques can be utilized with this rule based approach to move towards obtaining a higher level of accuracy that may desired/required.

For instance, by combining this system with speed measurement and storing of historic geographical location readings it is possible to utilize and assign dynamic scores/weightings for each motion state. This can help to achieve a finer granularity/resolution of the rule-based approach and increase the tracking accuracy. For example, for an in ‘vehicle’ motion state, a typical person may drive on highways (with average speed of about 70 mph/30 metres per second) or local roads (with average speed of around 20 mph/10 metres per second). With past geographical location readings (that have been done on a prior journey) it is possible to assign different values to SCORE_VEHICLE accordingly for current frame, or even to subdivide the ‘vehicle’ motion state weighting for the respective frames/locations.

Other embodiments also utilize rule personalization, whereby the actual speed of a person in various motion states is measured. For instance, different people may walk at different speeds and so the different weightings for the motion states should be adjusted accordingly. Again, a user could be asked to select a particular pre-determined sub-motion state (such as: slow paced walker, medium paced walker, fast paced walker, and the like, these sub-motion states being selected from a motion state profile available to the user).

Other embodiments can utilize historical data of a person or particular user. For example, a given person may typically commute along the same route between work and home. By detecting/discriminating this case (for example, via an up-to-date geographical location reading in conjunction with time of day) it is possible to tune the system to adapt accordingly.

In the first embodiment, the basic intuition is that the higher the speed of movement of the device, the faster the sampling rate (and vice versa). If the user remains stationary, a low sampling rate will be applied, or the geographical location sensor may even be turned off. Moreover, given that different people may have distinct everyday mobility patterns, for example, a student or office walker may spend most of his time sitting in the study/office, whereas a delivery man or a taxi driver will spend most of their day moving around. Such user mobility pattern may even change over time, for example, work days vs. weekends. Therefore, different people use their portable electronic devices at different rates, and use up an allocated power reserve in different times. This data can be used to control the geographical location sampling rate, for example, by monitoring the mobility patterns and/or selecting a (predetermined) mobility pattern (for example, over a period of time, or from a motion state profile).

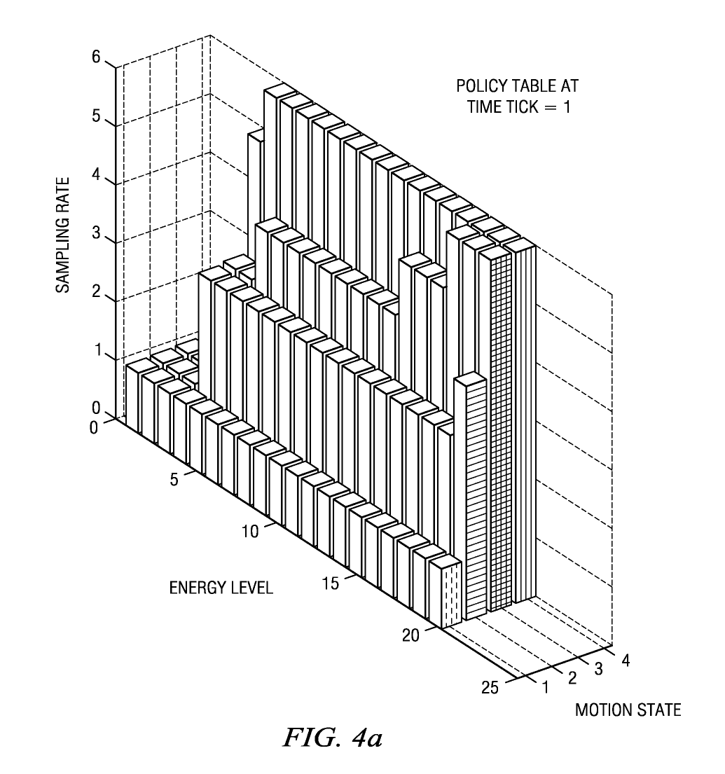

FIG. 3 illustrates an example of how a particular user may use up the power reserve of their device over an average general duty cycle (in other words, from full battery power reserve to no power left for operation of the device/charging becomes necessary). Every individual is unique and it can be hard to predict a given user's lifestyle pattern before hand, if not impossible. Therefore, it can be seen that there is a need for an adaptive power management system.

In a further embodiment, a learning system is utilized to help acquire knowledge about a given user's habits and optimize the sampling data rate for each individual user. An objective of this embodiment is to maximize the battery life and to minimize the impact on the service provided by the device at the same time.

In this embodiment, the system is modelled by a discrete-time Markov Decision Processes (MDP). A Markov Decision Process (see, for example, R. Bellman. A Markovian Decision Process. Journal of Mathematics and Mechanics 6, 1957) is a list of four-tuple (S, A, P, R), where S is the state space, A is the action space (i.e., different sampling rates), Pₐ(s, s′)=Pr(sⱼ=s′|sᵢ=s,aᵢ=a) is the probability that executing an action a in state s at time i will lead to state s′ at time j, and R(a, s) is the reward function for performing action a when in state s. A policy π is a mapping from S to A that determines an action for every state sεS. The quality of a policy is the expected sum of future rewards, which are discounted to ensure the cumulative sum of rewards is convergent to a finite value. γ is the discount rate and satisfies 0<γ≦1. The value of a state s under policy π is the expected sum of discounted rewards by following policy π from s, defined as

V_{π}(s)=R(a,s)+γΣ_{s′}P_{π(s)}(s,s′)V(s′).

If all the parameters in MDP are known, the optimal policy can be computed by solving the Bellman equation:

V(s)=maxₐ(R(a,s)+γΣ_{s′}P(s,s′)V(s′))

The Bellman equations are solved using the Value Iteration algorithm. If state transition probabilities are not known, the policies can be learned using reinforcement learning, such as Q-learning (see, for example, Sutton, R. S. and Barto A. G. Reinforcement Learning: An Introduction. The MIT Press, Cambridge, Mass., 1998).

MDP is commonly used for dynamic power management of portable systems, such as wireless interface card and laptops. It is also used in sensor networks for controlling the sampling rate of battery-powered sensors.

Some devices utilize accelerometer-assisted movement detection to schedule dynamic GPS location sensing. This simply detects whether device is moving or not, and does not consider the impact or possibility of looking at different motion states for adjusting geographical location sampling rates. In addition, the discussed power model does not take into account the total energy budget available for geographical location sensing.

To summarize, this embodiment is directed towards further addressing:

Limited energy budget and/or required operation time: The power consumption of geographical location sensing depends on the sampling rate. Higher frequency sampling consumes more power, and vice versa. In some context awareness applications, the geographical location sensing needs to be on for a desired time length before running out of power. So there can also be seen to be a constraint on the required operation time of the device.

Adaptive sensing: In most location based applications, the required quality of geographical location sensing varies depending on user's motion activity. When a user is stationary, the geographical location may be sampled at lower rate relative to when the user is moving. It can be useful to adapt the sampling rate to fit these various conditions of the user's mobility pattern and the device's performance.

We will now describe this further embodiment.

This embodiment is a model-based approach that is a further development of the first embodiment, but varies the sampling rate based on this MDP model and does so based on a different set of conditions/criteria. In this embodiment, the apparatus uses a Markov Decision Process (MDP) to take into account both the particular identified motion states and the (remaining) energy level of a battery of a portable electronic device in order to control the sampling rate.

The identification circuit, when identifying motion state, can correlate each state to a particular number (for example, every motion state can be divided into different levels, such as: 1=stationary, 2=walking, 3=running/cycling, 4=in vehicle, etc). These levels serve as identifiers for each particular identified state. Once identified, this information can be passed to the sampling control circuit.

The identification circuit in this embodiment is also capable of identifying the energy level of the battery of the portable electronic device (as well as identifying particular motion states as per the first embodiment). In this embodiment, the identification circuit quantizes the energy of the battery into discrete energy levels (in this example, the energy power reserve is quantized into 20 different levels). The identification circuit is therefore capable of identifying both a particular discrete motion state of the portable electronic device, and the remaining energy level of the device. The identification circuit is configured to provide an output onto the sampling control circuit 4 to indicate the particular motion state and the identified energy level of the battery at that time/iteration.

In this embodiment, the input 1 is also electrically connected to the battery of the portable electronic device to allow the identification circuit 3 monitor the power reserve of the battery of the portable electronic device at any given time instant.

The sampling control circuit is configured to utilize the MDP model to use the identified motion state and energy level to identify a sampling rate that is most suited to the given situation, in other words, a sampling rate that takes account of both the motion state and the amount of energy left. Although this is a stochastic system, influenced partly by random uncertain factors and also by decisions made by the apparatus, the MDP model helps to map out the how certain factors and decisions tend to affect the system for a given user and given set of states and energy levels.

In this embodiment the MDP model takes the following aspects into account:

1. The battery budget—In essence, the amount of battery power allocated to the geographical location sensing function (for example, 25% of a given battery, such as the N95 battery (1200 mA/h), 25% of which is 300 mA/h).

2. Rate of battery draining at a given sampling rate—This can be obtained using battery profiling.

3. Duration of geographical location sensing operation/session—It is helpful to know how long the geographical location sensor needs to be operational.

4. An individual user's daily mobility pattern—For example, whether a given user stays in the same place for a long time vs. driving/cycling around.

5. Provides an appropriate ‘reward’ function for different sampling rates—The reward reflects how a sampling rate fits a given mobility (speed of a device) so as to ‘reinforce’ particular sampling rates when it is found that they suit a particular motion state and energy level of the battery.

The skilled person will appreciate that this method is very flexible and that the above list of factors is not an exhaustive list of considerations, and that other factors could also be taken into account using such a model. Also, in some embodiments not all of the above factors need to be taken into account.

Once the sampling control circuit has modelled all of these aspects of the system, the circuit 4 uses a value iteration algorithm to compute a statistically optimal duty cycling policy. This output policy table is three-dimensional array. For each tuple (in other words, the entry that corresponds to a given current motion state, given battery level and a given time tick), there is a corresponding sampling rate that has been optimally calculated and selected in accordance with the abovementioned MDP model and value iteration algorithm. Once the policy is acquired, it is straightforward to use it. The system can just keeps track on the time and battery left so far and the current mobility inferred using accelerometer data.

This can allow for a policy to be generated once, and then used as a reference or lookup table for given motion states at given energy levels at a given time/tick. This can therefore allow for offline generation of such ticks using simulated mobility patterns. Such policy tables could be preloaded onto portable electronic devices, with different policies acting as different profiles that adjust appropriately for the lifestyle and mobility patterns of different users.

For example, policy tables for a low mobility pattern, a medium mobility pattern and a high mobility pattern could be preloaded onto a device and used according to the mobility pattern that a device is used in (for example, mobility profiles). In such embodiments, the sampling control circuit 4 in such situations could therefore be configured to store such policy tables and vary the sampling rate in accordance with the information encoded within the policy table. In other embodiments the sampling control circuit may be configured to both store policy lookup tables as well as being able to generate such policy tables. The skilled person will appreciate that there are many such variations possible according to the present disclosure.

We will now describe in detail an example MDP model with reference to various mathematical equations that can be used to govern this model.

Where motion states can be determined for a device that can sample geographical location data, there are a number of different states linking the two aspects. Using the MDP model, the composite state machine generated from these three variables (in other words, motion level, remaining energy budget and time tick) is represented as sᵢ=(m_{accel}(i),e_{gps}(i),tᵢ), 0≦tᵢ≦T, where tᵢ is the current time tick and T is the total number of time ticks. In the above discrete-time model, the total amount of time Tₛ (seconds) is quantized into T time ticks such that each time tick takes tₛ=Tₛ/T seconds. The time tick is set as a dimension of the composite state so that the learned policy will change according to time index. The time tick transition probability strictly increases by ‘1’ with each tick and is modeled as a degenerate Markov chain,

$$P ( {t}_{j} \vert {t}_{i} ) = \{ \begin{matrix}1 & if {t}_{i} = {t}_{j} = T \\ 1 & if {t}_{j} = {t}_{i} + 1. \\ 0 & otherwise .\end{matrix}$$

The state transition probabilities {P(m_{accel}(j)=k|m_{accel}(i)=l), 1≦k,l≦4} can be estimated from a long history of activity traces.

The action space A contains all possible sampling rates. For example, A={k|every g(k) time units}. For example, the level of sampling rate is set as:
Levels of sampling interval/rate: g(1)=20 minutes, g(2)=10 minutes, g(3)=5 minutes, g(4)=2 minutes, g(5)=1 minutes, g(6)=1 sec (always on).

For some assisted-GPS enabled devices (such as the Nokia™ N95™, assisted GPS meaning that the GPS receiver receives satellite signal frequencies through the cellular network) the GPS system has to tune to and lock with the actual signals before the location can be determined. This can introduce a delay due to continuously requesting of sample data. This request delay can take several seconds. The power-off delay for GPS is about 30 seconds on the N95™. In view of this, a sampling interval of 1 second can be selected for always-on continuous sampling, or an interval of 1 minute (or higher) can be selected for on-and-off sampling with one GPS/geographical location reading only.

e_{gps}(i) represents the state of the remaining energy available for geographical location data sampling (energy budget) at time tick i. As discussed above, the energy of the battery available for geographical location sensing operation (in other words, energy budget E) is subdivided into L levels. This allows for the modelling of the transitional probability of e_{gps}(i) as a function of GPS sampling rate aεA, such as

$${P}_{a} ( {e}_{gps} ( j ) \vert {e}_{gps} ( i ) ) = \{ \begin{matrix}1 & if {e}_{gps} ( j ) = {e}_{gps} ( i ) = 1 \\ 1 - p ( a ) & if {e}_{gps} ( j ) = {e}_{gps} ( i ) = l , l \neq 1 \\ p ( a ) & if {e}_{gps} ( j ) = {e}_{gps} ( i ) - 1 \\ 0 & otherwise\end{matrix}$$

The probability p(a) is proportionally higher for higher sampling rates.

Since the activity state m_{accel}(i), remaining energy state e_{gps}(i) and time tick tᵢ are mutually independent, the overall state transition can be defined as:

Pₐ(sᵢ,sⱼ)=P(m_{accel}(j)|m_{accel}(i))·(e_{gps}(j)|e_{gps}(i))·P(tⱼ|tᵢ).

The reward function that the MDP model provides takes into account the geographical location sampling rate and the level of activity status. There is a penalty defined in the reward function if the energy consumed by the geographical location sensing operation reaches the total available energy budget E before the end of the desired system operation time T. According to this rule, we define

$$R ( [ ( {m}_{accel} ( i ) , {e}_{gps} ( i ) , {t}_{i} ) , a ] ) = \{ \begin{matrix}- {R}_{nopower} & if {e}_{gps} ( i ) = 1 , {t}_{i} < T \\ {k}_{{m}_{accel} ( i )} \cdot f ( {m}_{accel} ( i ) , a ) & otherwise ,\end{matrix}$$

where kₘ_{_{accel}}₍ᵢ₎ is a reward adjustment coefficient according to the motion level and f(m_{accel}(i),a) is the reward of taking action a when the motion level is m_{accel}(i), usually defined as f(m_{accel}(i),a)=m_{accel}(i)·a.

For illustrative purposes, we will now consider an example portable electronic device (for example, the Nokia™ N95™). In this case, it is assumed that the total energy budget E=300 milliampere-hour=4000 Joule and operation time Ts=12 hours=43200 seconds. The energy budget is divided into L=20 levels—each level therefore has energy of 200 Joule. The time axis is discretized/quantized into T=300 time index ticks and then each tick takes 144 seconds.

The transition probability p(a) of energy levels can be calculated as Power(a) (watt)*144 seconds/200 Joule accordingly. Power(a) is measured and illustrated in FIG. 3. For the sampling rate defined in space A above, {p(a),aεA}=[0.0017,0.0256,0.0338,0.1419,0.2557,0.2750].

The transition matrix of motion states can be learned over a long period of user's mobility pattern. For example, state transition matrix can be estimated from one user's typical weekday motion trace based on 2.5 minutes sampling interval (144 sec per time tick length):

$$P ( {m}_{accel} ( j ) = k \vert {m}_{accel} ( i ) = l ) = [ \begin{matrix}0.9622 & 0.0207 & 0.0123 & 0.0047 \\ 0.0756 & 0.8254 & 0.0725 & 0.0265 \\ 0.1880 & 0.2159 & 0.5290 & 0.0671 \\ 0.0492 & 0.0544 & 0.0326 & 0.8638\end{matrix} ] ;$$

The GPS power consumption profile can be encoded implicitly into the shape of reward metric f(m_{accel}(i),a), such as:

$$\begin{matrix}[ 16 , 16 , 16 , 16 , 16 , 16 ; & \% stationary \\ 0.1 , 8 , 13 , 14 , 15 , 16 ; & \% walking \\ 0.1 , 2 , 8 , 14 , 15 , 16 ; & \% running \text{/} cycling \\ 0.1 , 1.5 , 2 , 8 , 15 , 16 ; ] & \% in vehicle\end{matrix}$$

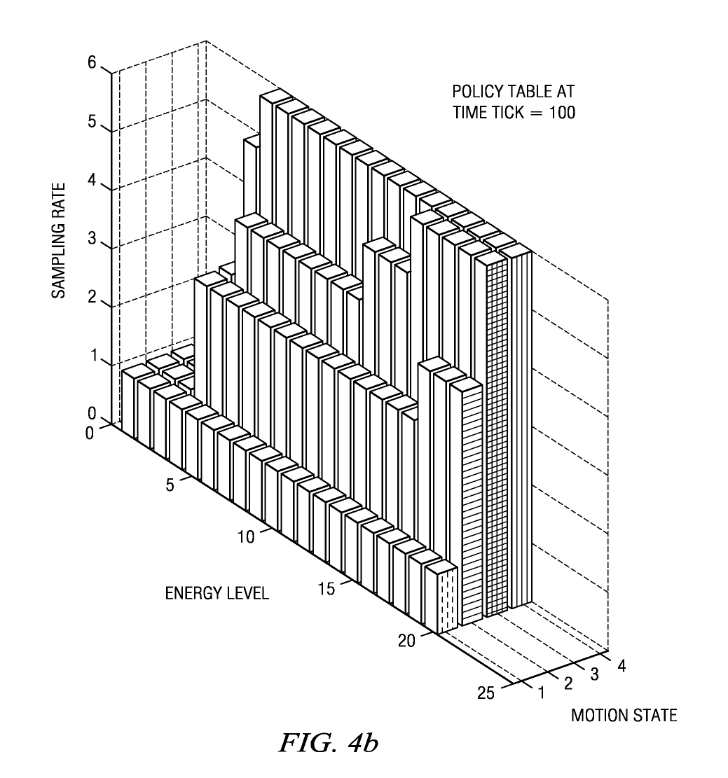

A reasonable/appropriate adjustment coefficient can be applied for different motion states. After running the MDP value iteration algorithm, the optimal control policy table of GPS sampling rates can be generated at every time tick from 1 to 300, for all twenty energy levels and four motion states, thus generating the policy table to govern sampling rates for each of these variables. FIGS. 4a-4d illustrate a possible 3 dimensional array sampling policy table at different time ticks (at time tick 1, 100, 200 and 300 respectively). The table clearly varies over time in accordance with the identified particular motion state and current energy level.

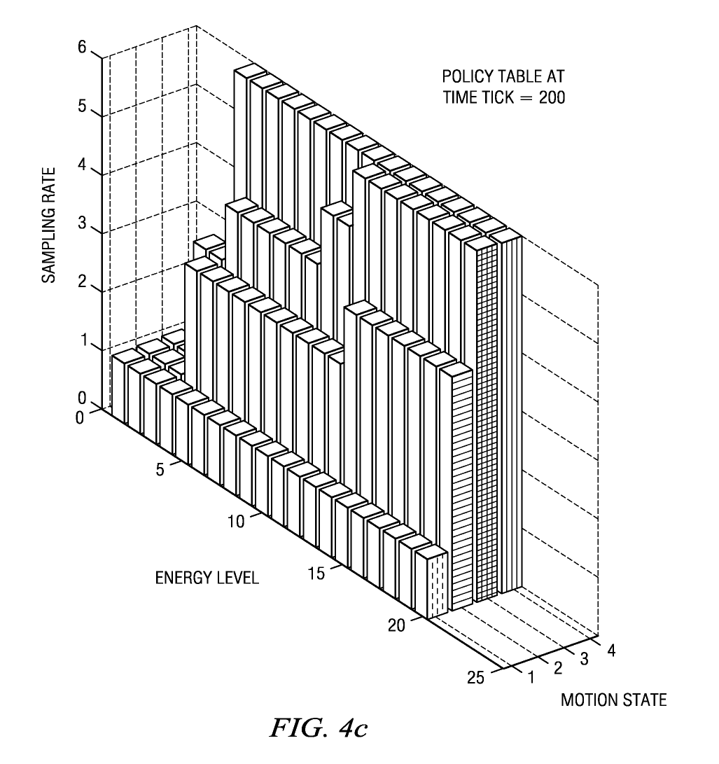

An adaptive geographical location sampling scheme is generated based on a number of motion state sequences generated from P(m_{accel}(j)=k|m_{accel}(i)=l), as shown in FIGS. 5a and 5b. FIG. 5a illustrates sampling rates generated by the MDP model with energy level (Y-axis) over 300 time ticks (X-axis). FIG. 5b illustrates sampling rates generated by the MDP model with energy level (Y-axis) at every 4 seconds time step (X-axis).

In FIG. 5a, the same sampling rate is used over 300 time ticks (every 144 seconds per time tick). To justify that the model has time-discrete nature, the same policy table is used to control the sampling rates over 10800 time ticks (every 4 seconds per time tick) in FIG. 5b, as the motion recognition engine outputs an identified motion state every 4 seconds. From the simulation results, it can be seen that this MDP model based approach can track user's motion states as well as maintain the energy budget and operation time in an adaptive and advantageous manner.

This model also allows for detection of changes in a user's mobility patterns. The current pattern can be modelled using a joint first-order distribution. There are a number of different metrics that can be used to measure the variation/distance between two distributions, such as Kullback-Leibler divergence. Once the variation/distance between the current pattern and the old pattern reaches a threshold, the MDP model can be triggered to generate and obtain a new policy table for the new pattern.

As an illustration, the motion transition model for a given situation is the following matrix (a motion-active user):

$$P ( {m}_{accel} ( j ) = k \vert {m}_{accel} ( i ) = l ) = [ \begin{matrix}0.800 & 0.067 & 0.067 & 0.066 \\ 0.067 & 0.800 & 0.067 & 0.066 \\ 0.067 & 0.067 & 0.800 & 0.066 \\ 0.067 & 0.067 & 0.066 & 0.800\end{matrix} ] ;$$

The results from an MDP simulation are illustrated in FIG. 5c. FIG. 5c illustrates these sampling rates generated by the MDP model for a user with an active mobility pattern.

The learned policy table of GPS sensing is therefore adaptive to a user's mobility pattern change. Before time tick 6000, the policy is aggressively adapted to the motion states, while after time tick 6000, the policy becomes more conservative when user is moving to take into account the dwindling/diminishing energy levels (as the energy level is already below level 6).

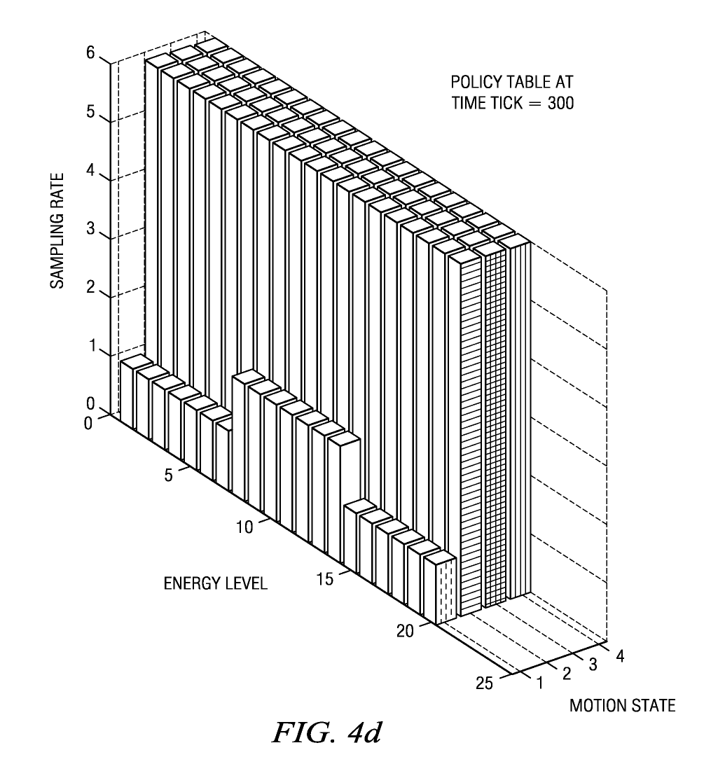

This overall system arrangement for this second MDP model method is illustrated in FIG. 6. This figure illustrates an example system which operates on the principles set out in the above examples/embodiments. In this figure, a low-power accelerometer sensor 501 is used to detect the motion state of mobile users by existing accelerometer based activity recognition technology. The user's mobility pattern transition is modelled (see user mobility modelling 502) by a first-order Markov Decision Process 503 and learned over a history of motion traces. Then it is combined with mobile device's GPS power profiling (GPS energy consumption profile 504) as inputs to the MDP model introduced above. The learned policy table generated from the MDP model may be used to control the GPS sampling rate adaptively to user's mobility status and device's available energy level (see adaptive location sensing 505). As has already been illustrated, it is possible for an optimal control policy of GPS sampling rates to be generated from an offline MDP model. This can allow for offline learning of different user's mobility patterns and further used to perform adaptive location sensing based on real-time user mobility patterns.

With regards to specific advantages of the abovedescribed embodiments/methods, a common advantage of both the rule-based approach and the MDP model-based approach is that it allows for maintaining location sensing accuracy whilst helping to reduce intensive power consumption associated with such operations. Given the same energy budget, the running time of battery-power mobile devices using this method can be much longer than that of fixed periodic sampling as is known in the art.

One advantage of the rule-based approach is that it is computationally light weight and can be implemented easily without substantial additional computational support/effort whilst providing for improved motion recognition and adaptation in accordance with detected motion speed of a user. This means many location-based services can be easily deployed and adjustable/adaptable to user's mobility patterns.

One advantage of the MDP model-based approach is that its optimal sampling policy can be generated offline. Only the policy table needs to be ported to mobile devices. Therefore in some embodiments, the sampling control circuit may be located elsewhere and the generated policy table can be provided as a lookup table for given devices. When the system is deployed, the appropriate sampling rate can be looked up from policy table based on accelerometer-enabled motion recognition and used to control GPS sampling rates. Thus, the deployment of this method has a very low computational load.

As has been discussed, there is no single general policy that is suitable for all users. However, users with similar mobility patterns may be able to share policies with each other. The MDP model does not require different users to have similar daily schedules, it is sufficient provided that those users have similar motion transitional patterns in their daily activities. In other words, the MDP model is flexible enough to cater for different users provided that their first-order distribution statistics are similar. As MDP is inherently stationary and time-invariant, the dynamic programming optimization process takes all possible activity sequences into account.

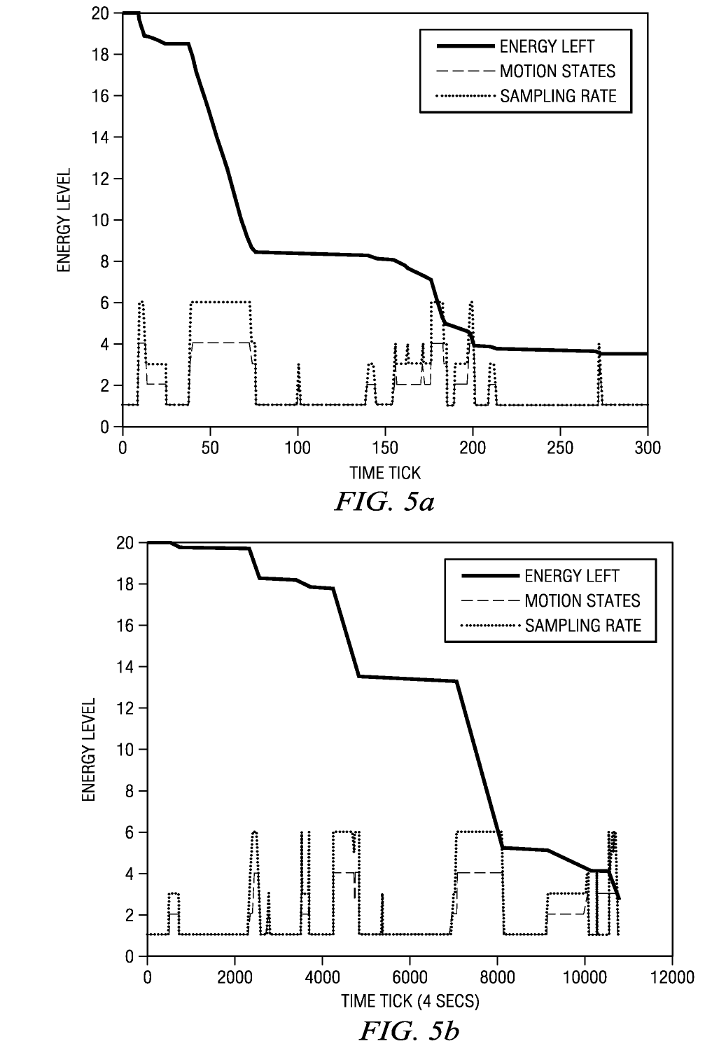

FIG. 7 illustrates the method of operation of at least the first embodiment (discussed above). This method comprises:
301—identifying a particular motion state of a portable electronic device; and
302—varying the geographical location data sampling rate for the portable electronic device based on the identified particular motion state of the portable electronic device. As both of these steps have been discussed at length above, these will not be discussed further here.

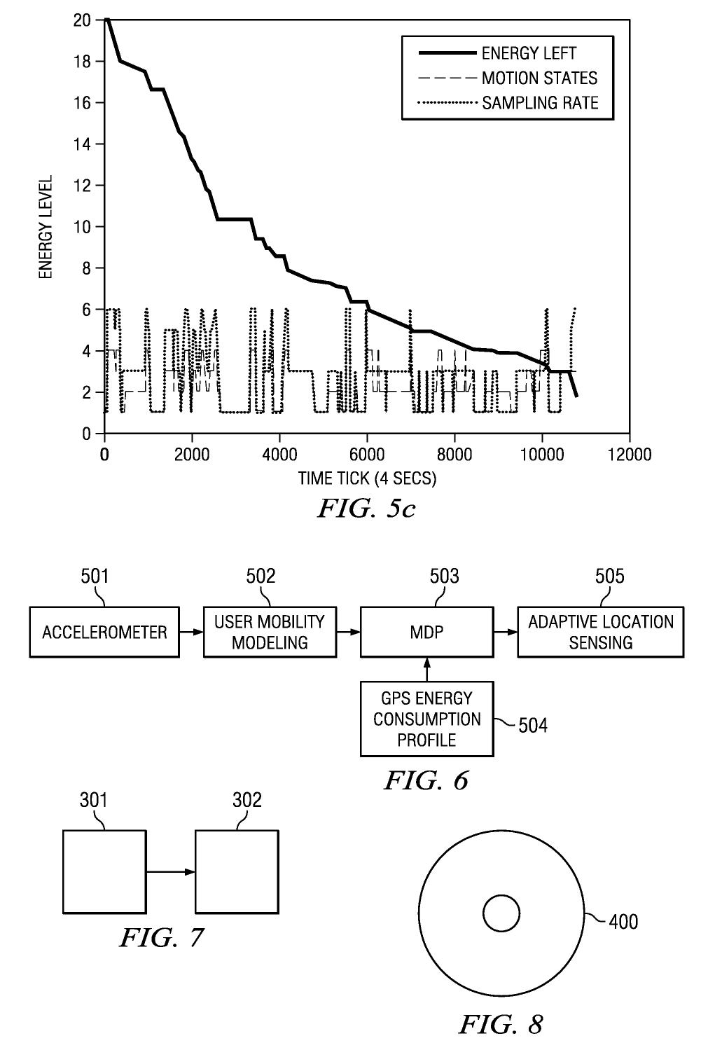

FIG. 8 illustrates schematically a computer/processor readable media 400 providing a program according to an embodiment of the present invention. In this example, the computer/processor readable media is a disc such as a digital versatile disc (DVD) or a compact disc (CD). In other embodiments, the computer readable media may be any media that has been programmed in such a way as to carry out an inventive function.

It will be appreciated to the skilled reader that any mentioned apparatus/device and/or other features of particular mentioned apparatus/device may be provided by apparatus arranged such that they become configured to carry out the desired operations only when enabled, for example, switched on, and/or the like. In such cases, they may not necessarily have the appropriate software loaded into the active memory in the non-enabled (for example, switched off state) and only load the appropriate software in the enabled (for example, on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (for example, memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

One or more embodiments of the present disclosure may apply to location determination systems such as GPS, A-GPS, and other equivalents thereof (for example, Galileo satellite navigation system).

It will be appreciated that the term “signalling” may refer to one or more signals transmitted as a series of transmitted and/or received signals. The series of signals may comprise one, two, three, four or even more individual signal components or distinct signals to make up said signalling. Some or all of these individual signals may be transmitted/received simultaneously, in sequence, and/or such that they temporally overlap one another.

With reference to any discussion of any mentioned computer and/or processor and memory (for example, including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus configured to:
identify a particular motion state of a portable electronic device; and
vary the geographical location data sampling rate for the portable electronic device based at least partially on the identified particular motion state of the portable electronic device.

2. The apparatus as claimed in claim 1, wherein the apparatus is configured to identify a particular motion state based at least partially on one or more of detected: speed, direction, velocity, acceleration, deceleration, forces, torque, and/or change in any of these quantities experienced by the portable electronic device.

3. The apparatus as claimed in claim 1, wherein the particular motion state is selected from a group comprising one or more of: stationary, walking, running, cycling and/or in-vehicle.

4. The apparatus as claimed in claim 1, wherein each of the motion states is associated with a particular sampling rate, the apparatus being configured to vary the geographical location sampling rate based at least partially on the particular sampling rate associated with the particular identified motion state.

5. The apparatus as claimed in claim 1, wherein each of the particular motion states is associated with a particular weighting, the apparatus being configured to accumulate the respective weightings of one or more identified motion states and compare the accumulated weighting value to a predetermined threshold to determine the sampling rate.

6. The apparatus as claimed in claim 1, wherein the apparatus is also configured to:
identify a particular energy level of the portable electronic device; and
vary the geographical location data sampling rate for the portable electronic device based at least partially on the identified particular motion state and the identified particular energy level of the portable electronic device.

7. The apparatus as claimed in claim 6, wherein the apparatus is configured to be able to access a policy table, wherein the policy table stores a plurality of sampling rates, each sampling rate being associated with a particular motion state and a particular energy level of the portable electronic device, the apparatus being configured to vary the geographical location data sampling rate in accordance with the particular sampling rate associated with the identified motion state and the identified energy level of the portable electronic device.

8. The apparatus as claimed in claim 7, wherein the policy table is generated/populated in accordance with a Markov Decision Process.

9. A processor configured to:
identify a particular motion state of a portable electronic device; and
vary the geographical location data sampling rate for the portable electronic device based on the identified particular motion state of the portable electronic device.

10. An apparatus comprising the processor of claim 9, and a memory including computer program code, wherein the memory and the computer program code configured to, with the processor, cause the apparatus at least to
identify a particular motion state of a portable electronic device; and
vary the geographical location data sampling rate for the portable electronic device based on the identified particular motion state of the portable electronic device.

11. A portable electronic device comprising the apparatus of claim 1.

12. A method comprising,
identifying a particular motion state of a portable electronic device; and
varying the geographical location data sampling rate for the portable electronic device based on the identified particular motion state of the portable electronic device.

13. A method as claimed in claim 11, wherein identifying a particular motion state based at least partially on one or more of detected: speed, direction, velocity, acceleration, deceleration, forces, torque, and/or change in any of these quantities experienced by the portable electronic device.

14. A computer readable medium comprising a computer program stored thereon, the computer program comprising:
program code for identifying a particular motion state of a portable electronic device; and
program code for varying the geographical location data sampling rate for the portable electronic device.
